(19) United States
(12) Patent Application Publication
(10) Pub. No.: US 2013/0275075 A1
(43) Pub. Date: Oct. 17, 2013

(54) Water Bottle with Electronic Consumption Counter

(71) Applicant: Jeffrey T. Johnson, Kaysville, UT (US)

(72) Inventor: Jeffrey T. Johnson, Kaysville, UT (US)

(21) Appl. No.: 13/856,744

(22) Filed: Apr. 4, 2013

Related U.S. Application Data
(60) Provisional application No. 61/622,796, filed on Apr. 11, 2012.

(51) Int. Cl. G06M 1/00

(52) U.S. Cl. CPC G06M 1/00
USPC 702/127

(57) ABSTRACT

A water bottle consumption counter apparatus includes a bottle having a bottom, a top, and a continuous side wall extending upwardly from the bottom to the top, the bottle defining a reservoir and an opening defined by the top in communication with the reservoir. A control module is mounted to the bottle bottom and defines an interior area. A processor is situated in the control module interior area. A battery is also situated in the control module interior area and electrically connected to the processor. A timer is electrically connected to the processor. At least one input and one output are positioned on the exterior of the bottle side wall and electrically connected to the processor. The processor is configured to actuate the output when the input is actuated.

### REFERENCE TO RELATED APPLICATIONS

This non-provisional patent application claims the benefit of provisional application Ser. No. 61/622,796 filed on Apr. 11, 2012, titled Water Bottle with Electronic Consumption Counter.

### BACKGROUND OF THE INVENTION

This invention relates generally to electronic counters and, more particularly, to a water bottle having an electronic consumption counter.

Water is very important to a person's health in that water is the principal component and makes up about 60 percent of the human body. Water flushes toxins out of the body, carries nutrients to one's cells, and provides a moist environment for ear, nose, and throat functions. For these reasons, many people try to keep track of the quantity of water they consume on a daily basis. Although there is no absolute rule or formula for how much water a person should consume every day, various general proposals are frequently advanced. For instance, some would say a person should consume eight 8 ounce cups of water per day or that 2 to 3 liters of water should be consumed.

Although a person may attempt to keep track of the number of cups or bottles of water he has consumed by marking a tally on paper or stacking the empty disposable water bottles, it is usually the case that an accurate quantity of water consumed is not kept accurately.

Therefore, it would be desirable to have a water bottle that includes an electronic consumption counter that will manually and visually indicate the number of times the container's liquid has been consumed and refilled.

### SUMMARY OF THE INVENTION

A water bottle consumption counter apparatus includes a bottle having a bottom, a top, and a continuous side wall extending upwardly from the bottom to the top, the bottle defining a reservoir and an opening defined by the top in communication with the reservoir. A control module is mounted to the bottle bottom and defines an interior area. A processor is situated in the control module interior area. A battery is also situated in the control module interior area and electrically connected to the processor. A timer is electrically connected to the processor. At least one input and one output are positioned on the exterior of the bottle side wall and electrically connected to the processor. The processor is configured to actuate the output when the input is actuated.

Therefore, a general object of this invention is to provide a water bottle consumption counter apparatus that enables a user to keep track of how many times the bottle has been consumed/refilled within a period of time.

Another object of this invention is to provide a consumption counter apparatus, as aforesaid, that includes a visual consumption counter on an exterior of a water bottle that indicates the number of times the contents of the bottle have been consumed.

Still another object of this invention is to provide a consumption counter apparatus, as aforesaid, that includes an input button by which a user may increment the visual consumption counter.

Yet another object of this invention is to provide a consumption counter apparatus, as aforesaid, in which the consumption counter output is a plurality of spaced apart lights.

A further object of this invention is to provide a consumption counter apparatus, as aforesaid, that is easy to use.

Other objects and advantages of the present invention will become apparent from the following description taken in connection with the accompanying drawings, wherein is set forth by way of illustration and example, embodiments of this invention.

### BRIEF DESCRIPTION OF THE DRAWINGS

FIG. 1a is a perspective view of a water bottle consumption counting apparatus according to a preferred embodiment of the present invention;

FIG. 1b is a perspective view of a water bottle consumption counting apparatus according to another embodiment of the present invention;

FIG. 2 is an exploded view of the consumption apparatus as in FIG. 1a;

FIG. 3 is a block diagram of the consumption apparatus as in FIG. 1a; and

FIG. 4 is a flow chart illustrating a method of using the consumption apparatus as in FIG. 3.

### DESCRIPTION OF THE PREFERRED EMBODIMENT

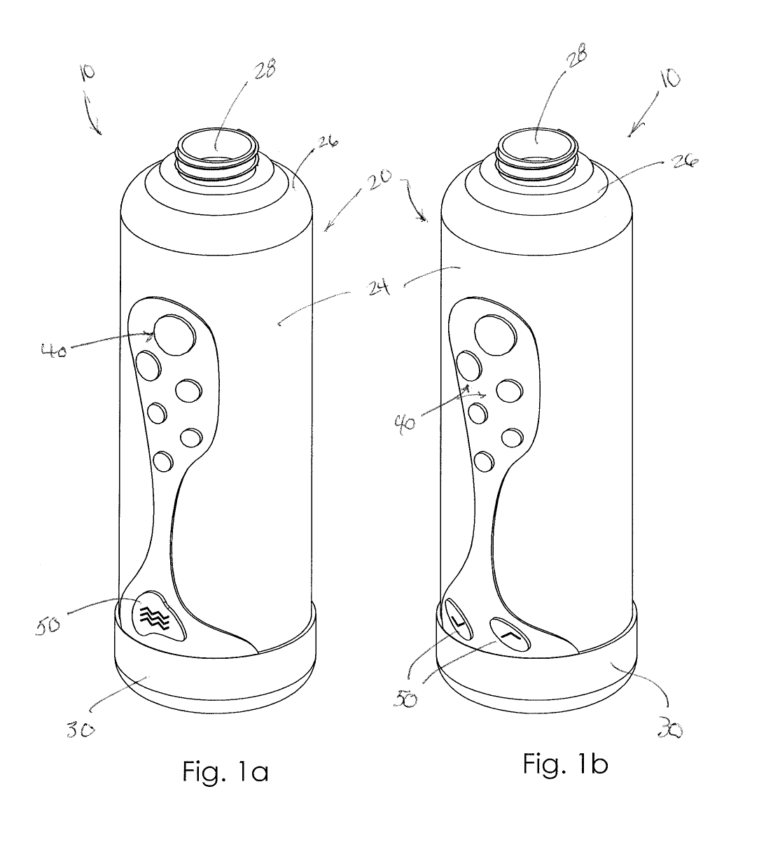

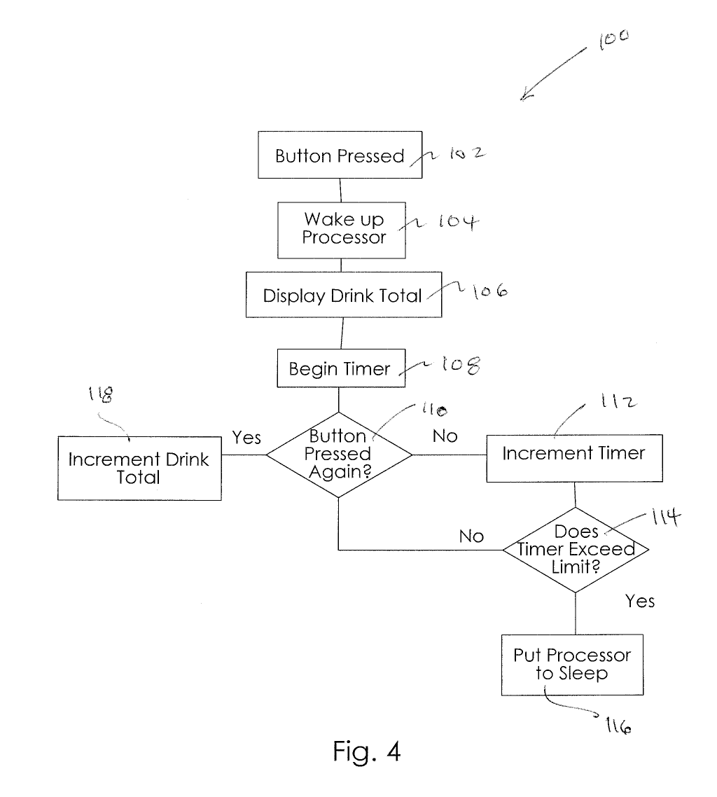

A water bottle consumption counting apparatus will now be described with reference to FIGS. 1 to 4 of the accompanying drawings. The consumption counting apparatus 10 includes a bottle 20, a control module 30, a processor 32 in the control module, at least one input member 50 and at least one output member 40 electrically connected to the processor 32.

The bottle 20 includes a configuration substantially similar to a traditional water bottle. More particularly, the bottle 20 may include a bottom 22, a continuous side wall 24 extending upwardly from the bottom 22, and a top 26. Preferably, the bottle 20 includes a cylindrical configuration and defines an inner reservoir configured to contain a liquid such as water. The top 26 may define an opening 28 selectively covered by a cap (not shown), the opening 28 being in communication with the reservoir through which a liquid may be selectively deposited and withdrawn. To this extend, the bottle 20 is substantially similar to a traditional water bottle.

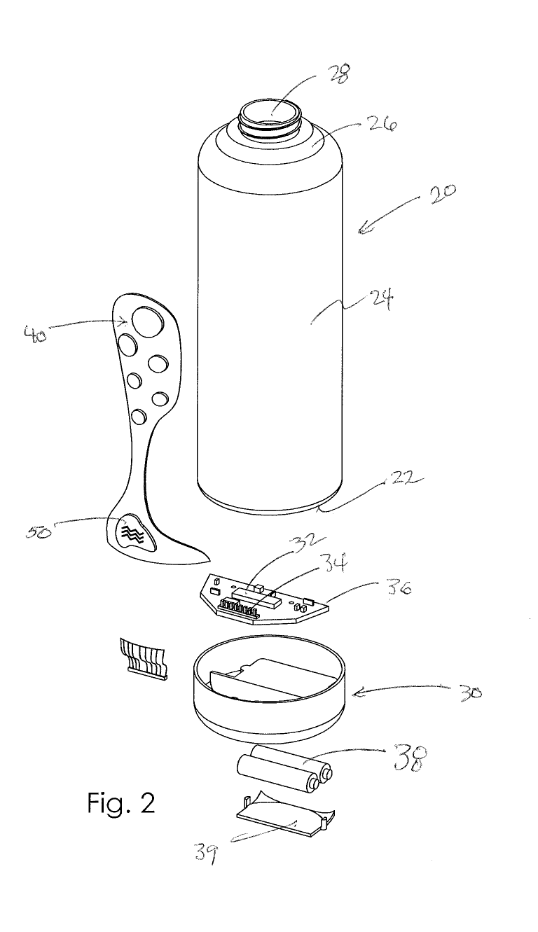

The control module 30 (which may also be called an “electronics box”) is coupled to the bottom 22 of the bottle 20 and includes a bottom wall and continuous side wall that defines an interior area suitable to contain electronic components as described below. A processor 32 may be situated inside the control module interior area. The processor 32 may be connected to a memory component 33 configured to store a consumption count as will be discussed later. A timer circuit 34 may also be situated inside the control module interior area and electrically connected to the processor 32. It is understood that the processor 32 may be electronically connected to a memory 33 having program instructions or, alternatively, be included in an integrated circuit 36 (FIG. 2). A battery 38 (or multiple batteries) may also be positioned in the control module interior area and electrically connected to the processor 32. The battery 38 may be accessible through a batter door 39.

The consumption counting apparatus 10 includes at least one but preferably a plurality of output members 40. The plurality of output members 40 may be a plurality of light emitting diodes (LEDs) coupled to an exterior surface of the bottle side wall 24 (FIG. 1a). Some of the plurality of LEDs may be larger than other of the plurality of lights as will be discussed further below. Preferably, each light is spaced apart from an adjacent light and are situated in a generally upward pattern situated between the bottle bottom 22 and top 26. Each output member 40 is electrically connected to the processor 32 and related circuitry, such as through wires or integrated circuitry. In some embodiments, a singular output such as an electronic display (not shown) may be used to display a consumption count.

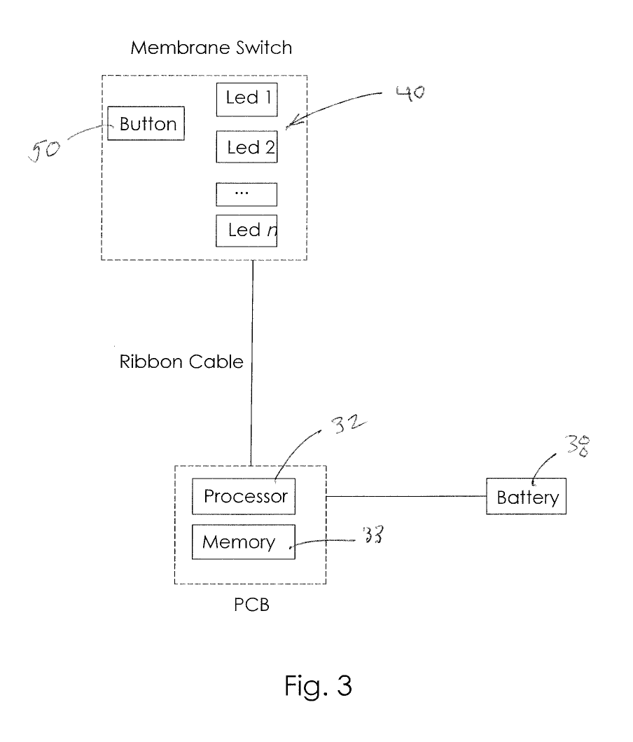

The consumption counting apparatus 10 includes at least one input member 50, such as an input button (FIG. 1a). The at least one input button 50 may be coupled to the exterior surface of the bottle side wall 24 (FIG. 1a) and is electrically connected to the processor 32 (FIG. 3). It is understood that the output member 40 (plurality of LEDs) and input member 50 may be included on a single “membrane switch” having a flexible configuration that is coupled to the bottle exterior surface. In some embodiments, more than one input member 50 may be included. As shown in FIG. 1b, the input may include a first button that, in cooperation with the processor 32, causes a consumption count to be incremented and a second button that, in cooperation with the processor 32, causes a consumption count to be decremented.

The processor 32 is configured to calculate, maintain, and display a consumption count associated with a number of bottles of a liquid contained therein have been consumed by a user. Operation of a method 100 of using the water bottle consumption count apparatus 10 is best understood with reference to the flowchart of FIG. 3. When a user presses the input member 50 at step 102 the processor 32 “wakes up” 104 so as to determine if a consumption counter is to be incremented. More particularly, the processor 32 is not energized by the battery 38 during what may be long periods of inactivity so as to conserve battery power. But when the input member 50 is actuated, the processor 32 is energized. The first operation of the processor 32 after being energized is to display the current consumption count at step 106, the current consumption count being retrieved from memory 33. In the preferred embodiment, the current consumption count is indicated by energizing a corresponding number of the plurality of lights. For instance, if the consumption count is “3,” then the processor 32 sends appropriate signals to three of the LEDs to illuminate. The current consumption count may be a parameter that is stored in memory 33 electrically connected to the processor 32.

At step 108, the processor 32 actuates a timer circuit 34 to count down from a predetermined quantity of time. The intention of the timer 34 is to determine if the processor 32 has been inactive for a predetermined amount of time and, if so determined at step 114, to de-energize the processor 32, i.e. to put the processor 32 back to “sleep” as indicated at step 116. At step 110, the processor 32 determines if the input member 50 has been pressed a second time and, if so, then the consumption counter is incremented and saved to memory 33 at step 118. As described above, a previously un-energized light of the output member 40 will be energized upon actuation of the input member 50. Some lights of the output member 40 may be larger than others so that larger lights become illuminated as a larger quantity of a liquid has been consumed. In this way, a user may be encouraged by accomplishing a goal regarding quantity of water to be ingested daily.

On the other hand, if the input member 50 is not actuated, the timer circuit 34 is allowed to continue (incremented or decremented depending on if the timer 34 counts upwardly or downwardly) at step 112. After step 112, the process 100 continues to step 114 where it is determined if the timer has exceeded a predetermined amount of time and, if so, proceeds to step 116 where the timer 34 is de-energized. It is understood that the present apparatus 10 may also include a means for resetting a consumption count to zero, such as at the beginning or end of a day.

Accordingly, the water bottle consumption counter apparatus 10 enables a user to manually keep a count of how many times he has filled and consumed a bottle of water.

It is understood that while certain forms of this invention have been illustrated and described, it is not limited thereto except insofar as such limitations are included in the following claims and allowable functional equivalents thereof.

1. A water consumption counting apparatus for use in counting a number of bottles of water that are consumed by a person, the consumption counting apparatus, comprising:
a bottle having a bottom, a side wall extending upwardly from the bottom, and a top connected to an upper end of the side wall, the bottom, side wall, and top together defining an inner reservoir configured to hold water;
a control module coupled to an exterior surface of said bottle, said control module defining an interior area;
a battery;
a memory having a plurality of programming instructions;
a processor electrically connected to said battery and to said memory, said processor configured to execute said programming instructions;
wherein said battery, said memory, and said processor are situated in said interior area of said control module;
an input member coupled to said exterior surface of said bottle and electrically connected to said processor;
a plurality of output members coupled to said exterior surface of said bottle and electrically connected to said processor;
programming in said memory that, when executed by said processor, causes said processor to determine when said input member has been manually actuated; and
programming in said memory that, when executed by said processor, causes said processor to energize a currently un-energized one of said output members when said input member is actuated.

2. The water consumption counting apparatus as in claim 1, wherein said bottle has a generally cylindrical configuration.

3. The water consumption counting apparatus as in claim 2, wherein said electronics module includes a bottom wall and a continuous side wall extending upwardly from said bottom wall, said side wall of said electronics module defining an open top and being removably coupled to said bottom of said bottle.

4. The water consumption counting apparatus as in claim 3, wherein said bottom wall of said electronics module includes a battery door that is selectively removable to give access to said battery situated in said interior area of said electronics module.

5. The water consumption counting apparatus as in claim 1, wherein said input member and said plurality of output members are coupled to a membrane switch which, in turn, is mounted flush upon an outer surface of said side wall of said bottle, said membrane switch having a flexible construction that is mounted flat on the cylindrical outer surface of said bottle side wall.

6. The water consumption counting apparatus as in claim 1, wherein each of said plurality of output members is a light emitting diode (“LED”).

7. The water consumption counting apparatus as in claim 6, wherein at least one of said plurality of output members is larger than another of said plurality of output members.

8. The water consumption counting apparatus as in claim 6, wherein each of said plurality of output members is spaced apart from another of said plurality of output members in a generally upwardly situated arrangement.

9. The water consumption counting apparatus as in claim 1, wherein said input member is a button situated on said side wall of said bottle.

10. The water consumption counting apparatus as in claim 1, wherein said memory includes a data structure to store a number indicative of a consumption count; said water consumption counting apparatus includes programming in said memory that, when executed by said processor, causes said processor to increment said consumption count when said input member is actuated.

11. The water consumption counting apparatus as in claim 10, wherein said input member includes:
a first input switch that, in cooperation with said programming instructions, causes said consumption count to be incremented; and
a second input switch that, in cooperation with said programming instructions, causes said consumption count to be decremented.

12. The water consumption counting apparatus as in claim 10, further comprising programming in said memory that, when executed by said processor, causes said processor to energize a number of said plurality of output members indicative of said consumption count.

13. A water consumption counting apparatus for use in counting a number of bottles of water that are consumed by a person, the consumption counting apparatus, comprising:
a bottle having a bottom, a cylindrical side wall extending upwardly from the bottom, and a top connected to an upper end of the side wall, the bottom, side wall, and top together defining an inner reservoir configured to hold water;
a control module coupled to said bottom of said bottle, said control module defining an interior area;
a battery;
a memory having a plurality of programming instructions;
a processor electrically connected to said battery and to said memory, said processor configured to execute said programming instructions;
wherein said battery, said memory, and said processor are situated in said interior area of said control module;
an input member coupled to said side wall of said bottle and electrically connected to said processor;
a plurality of output members coupled to said side wall of said bottle and electrically connected to said processor;
programming in said memory that, when executed by said processor, causes said processor to determine when said input member has been manually actuated; and
programming in said memory that, when executed by said processor, causes said processor to energize a currently un-energized one of said output members when said input member is actuated.

14. The water consumption counting apparatus as in claim 13, wherein said electronics module includes a bottom wall and a continuous side wall extending upwardly from said bottom wall, said side wall of said electronics module defining an open top and being removably coupled to said bottom of said bottle.

15. The water consumption counting apparatus as in claim 13, wherein said input member and said plurality of output members are coupled to a membrane switch which, in turn, is mounted flush upon an outer surface of said side wall of said bottle, said membrane switch having a flexible construction that is mounted flat on the cylindrical outer surface of said bottle side wall.

16. The water consumption counting apparatus as in claim 13, wherein each of said plurality of output members is a light emitting diode (“LED”).

17. The water consumption counting apparatus as in claim 16, wherein:
at least one of said plurality of output members is larger than another of said plurality of output members; and
each of said plurality of output members is spaced apart from another of said plurality of output members in a generally upwardly situated arrangement.

18. The water consumption counting apparatus as in claim 13, wherein said memory includes a data structure to store a number indicative of a consumption count; said water consumption counting apparatus includes programming in said memory that, when executed by said processor, causes said processor to increment said consumption count when said input member is actuated.

19. The water consumption counting apparatus as in claim 18, wherein said input member includes:
a first input switch that, in cooperation with said programming instructions, causes said consumption count to be incremented; and
a second input switch that, in cooperation with said programming instructions, causes said consumption count to be decremented.

20. The water consumption counting apparatus as in claim 18, further comprising programming in said memory that, when executed by said processor, causes said processor to energize a number of said plurality of output members indicative of said consumption count.
